(19) United States
(12) Patent Application Publication
(10) Pub. No.: US 2005/0005448 A1
(43) Pub. Date: Jan. 13, 2005

(54) Extruded pulley

(76) Inventor: Yeow Kiang Tan, Klang (MY)

Correspondence Address: Welsh & Katz, Ltd.;Jeffrey W. Salmon, Esq., 120 South Riverside Plaza, 22nd Floor, Chicago, IL, 60606, US

(21) Appl. No.: 10/841,340

(22) Filed: May 7, 2004

(30) Foreign Application Priority Data
Aug. 11, 2001 (WO) PCT/SG02/00263

(51) Int. Cl. F16H 7/14; B23P 17/00

(52) U.S. Cl. 29/892.3

(57) ABSTRACT

A method of forming a pulley, including: extrusion molding a body of the pulley; and producing at least one peripheral groove in the body so as to form the pulley. The invention also relates to a pulley (20) formed in accordance with the method.

### FIELD OF THE INVENTION

This invention relates to a pulley and a method of forming a pulley.

### BACKGROUND OF THE INVENTION

It is known to form a pulley by any one of a number of processes such as sand casting, die casting or metal stamping.

Sand casting, for example, involves the formation of a pulley cast from a mould. The mould is firstly positioned in a sand bed, in which a channel is also provided, to allow molten metal to be poured into the mould. After a curing and cooling period, the cast is removed by breaking the mould, such as by hammering, and transferred to a machining stage, to machine the pulley to appropriate standards and to cut grooves into the cast. The cast is preferable formed of iron ore. Impurities in the ore may cause small holes to be formed in the resulting cast, which subsequently need to be filled with putty and painted to provide a suitable finish and to prevent rusting.

The formation and machining of individual pulleys and the destruction of the mould each time a pulley is made, renders sand casting somewhat time consuming, labor intensive and expensive.

### OBJECT OF THE INVENTION

The present invention seeks to provide an alternative form of pulley and a method forming the pulley.

### SUMMARY OF THE INVENTION

In accordance with the invention, there is provide a method of forming a pulley, including:
extrusion molding a body of the pulley; and
producing at least one peripheral groove in the body so as to form the pulley.

Preferably, the method includes cutting the body from an extrusion prior to producing the at least one peripheral groove.

Preferably, the method includes formation of the body as a hollow section and, more preferably, the hollow section defines a central bore in the body.

Preferably, the central bore is formed with a keyway to secure the pulley against rotation relative to an axle passing through the central bore.

Preferably, the method includes machining a threaded hole through the body, toward the central bore, for receipt of a lock-screw, for securing the pulley on an axle passing through the central bore.

Preferably, the pulley is subsequently treated so as to be provided with a colored and/or protective anodised coating.

Preferably, the method includes forming the pulley of aluminum alloy, composite plastic or other suitable materials.

In another aspect, there is provided a pulley formed in accordance with the above described method.

### BRIEF DESCRIPTION OF THE DRAWINGS

The benefits and advantages of the present invention will become more readily apparent to those of ordinary skill in the relevant art after reviewing the following detailed description and accompanying drawings, wherein:

The invention is described, by way of example only, with reference to the accompanying drawings, in which:

FIG. 1 is a flow chart illustrating a manufacturing method for producing a pulley;

FIG. 2 is a perspective view of a pulley body;

FIG. 3 is a perspective view of another pulley body;

FIG. 4a to 4e illustrate pulleys of different length, with different numbers of grooves.

### DETAILED DESCRIPTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

In the present disclosure, the words “a” or “an” are to be taken to include both the singular and the plural. Conversely, any reference to plural items shall, where appropriate, include the singular.

Referring to the drawings, an embodiment of the present invention, directed to a method and apparatus for manufacturing an aluminum MMC (Metal Matrix Composite) disk rotor, is now explained in detail.

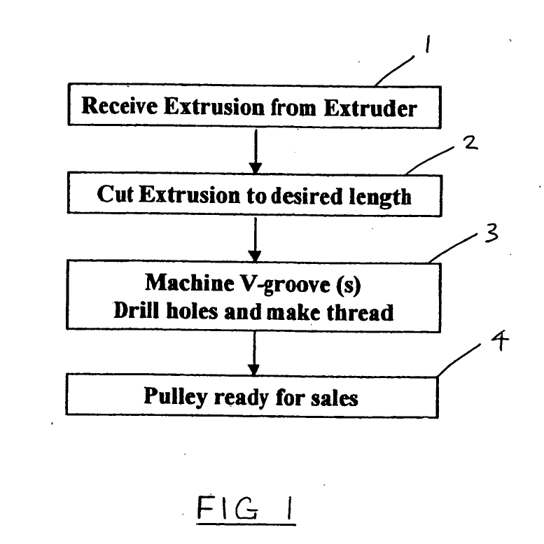

Referring firstly to FIG. 1 a flow chart illustrating a manufacturing method for producing a pulley is shown as including a first step 1, where an extrusion is received from an extruder and is subsequently cut by, for example, a circular saw, at step 2, to form a respective pulley body of a desired length. At step 3, one or more peripheral grooves are formed in the body and additional machining, such as the drilling of holes and the formation of thread, is performed. The machined pulley is then ready to be sold at step 4.

An example of a body 5, which ahs been cut from an extrusion, is illustrated in FIG. 2. As can be seen, the body 5 is formed as a hollow section which includes an outer sleeve 6 and an inner core 7 connected to the sleeve by interconnecting webs 8. The core 7 is provided with a central bore 9, which has a keyway 10 adapted to fit over a complimentary structure on an axle which passes through the bore 9, in order to secure the body 5 against rotation relative to the axle.

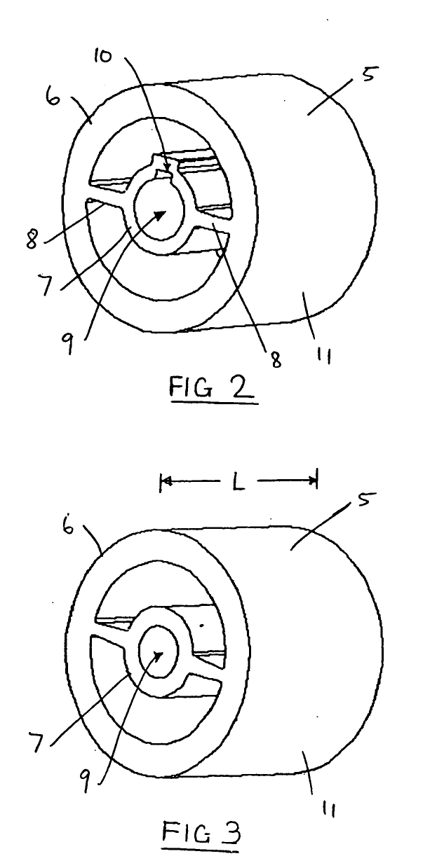

Another example of a pulley body 5 is illustrated in FIG. 3, wherein like reference numerals denote like parts. As can be seen, the body 5 is of essentially the same construction as that shown in FIG. 2, except that the keyway 10 in the central bore 9 is absent. As an alternative to the keyway 10, a threaded hole (not shown) may be provided in the core 7, extending toward the bore 9, for receipt of a locking screw, or the like, to secure the body 5 relative to an axle passing through the bore 9. The bore 9 may also be machined so as to include a thread, if required.

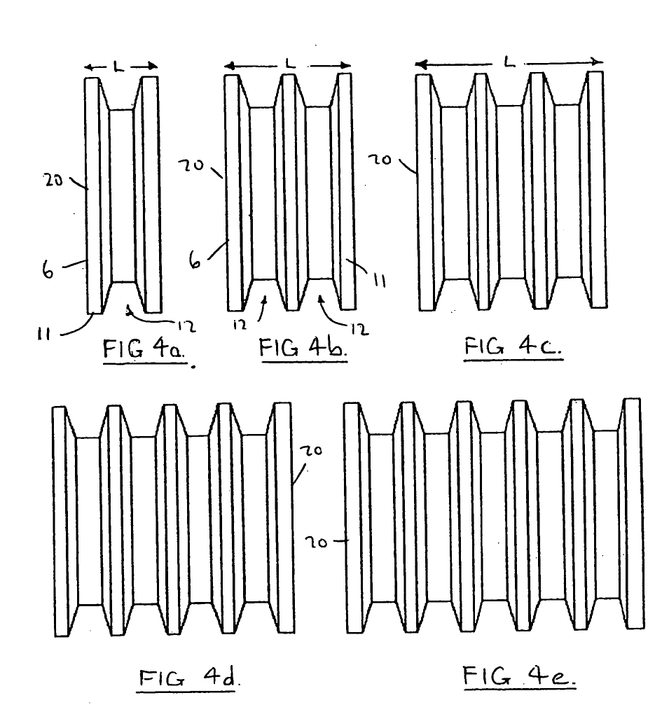

The body may be cut from the extrusion so as to have any desired length “L” and then transferred to the machining step 3 where an appropriate number of peripheral V-shaped grooves 12, for receipt of a respective transmission belt, or the like, may be formed in an external surface 11 of the sleeve 6 so as to produce the final form of the pulley 20. Various examples of pulleys 20 with different length dimensions and numbers of groves are illustrated in FIGS. 4a to 4e.

The pulley 20 is preferably formed of aluminum alloy which may be subsequently treated to have a colored anodised coating, if required. Alternatively, the pulley 20 may be formed of composite plastics or any other material suitable for extrusion molding.

As may be appreciated, the extrusion process allows the dimensions of the pulley to be fairly readily modified. For example, the diameter of the central bore 9, the size of the keyway 10, the thickness of the core 7, the thickness and number of the webs 8, the thickness of the sleeve 6 and the depth and dimensions of the grooves 12 may all be varied, as required. Further, the overall size of the pulley 20 is only limited by the minimum and maximum dimensions obtainable in the extrusion molding industry. In addition, a large number of pulleys may be manufactured using a single die for the extrusion process, with uniformity of design and sizes, which avoids secondary machining, as compared to a sand casting technique.

Accordingly, the invention may provide for cheaper start-up and operating costs, as compared to a conventional pulley formed by sand casting and pulleys can be made relatively quickly in large quantities, which allows for faster production time and mass manufacturing economics to be realized. The manufacturing method may also be computerized in which case a saving may also be made by reducing manual labor, which is also required with the sand casting technique.

Since the pulleys 20 may be manufactured from a reduced number of dies and in mass production, a reduction in required factory floor space may also result, as compared to a cast iron pulley manufacturing technique where the smelting and casting stages require a relatively large floor space. Using an extrusion process also avoids the production of any toxic fumes which may otherwise be generated using a conventional smelting technique. Further, an extrusion molding process will generally require less parts, which will also be manufactured to a relatively good component tolerance, and that will in turn require less inventory and allow for easier factory management.

Since the extrusion manufacturing process provide for mass production with minimal manpower, a relatively high turnover as per overhead costs may result. The extrusion manufacturing process can also provide a product without any small holes and no painting is required, which may lead to further cost savings.

The pulleys 20 may also be made of lighter material, as compared to the cast iron pulleys formed by sand casting. Lastly, cost advantages may be realized as a result of less inventory required to manufacture pulleys in accordance with invention and transport costs lessened due to the reduced weight of the product. In addition, the pulleys, which are preferably formed of aluminum alloy, may be manufactured of a material which is 100% recyclable.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A method of forming a pulley, including:
extrusion molding a body of the pulley; and
producing at least one peripheral groove in the body so as to form the pulley.

2. A method as claimed in claim 1, further including cutting the body from an extrusion prior to producing the at least one peripheral groove.

3. A method as claimed in claim 1, further including formation of the body as a hollow section, which defines a central bore in the body.

4. A method as claimed in claim 3, wherein the central bore is formed with a keyway to secure the pulley against rotation relative to an axle passing through the central bore.

5. A method as claimed in claim 3, further including machining a threaded hole through the body, toward the central bore, for receipt of a lock-screw for securing the pulley on an axle passing through the central bore.

6. A method as claimed in claim 1, wherein the pulley is subsequently treated so as to be provided with a colored and/or protective anodised coating.

7. A method as claimed in claim 1, wherein the pulley is formed of aluminum alloy.

8. A method as claimed in claim 1, wherein the pulley is formed of composite plastic or other suitable materials.

9. A pulley formed in accordance with the method of any one of claims 1 to 8.

10. A pulley as claimed in claim 3, wherein the hollow section includes an outer sleeve and a hollow core, interconnected by webs and the number of webs in the section can be varied.
